(19) United States
(12) Patent Application Publication
(10) Pub. No.: US 2002/0027105 A1
(43) Pub. Date: Mar. 7, 2002

(54) Composition and method for removing pernicious contaminants from aqueous wastestreams

(76) Inventor: Hal Alper, Flowery Branch, GA (US)

Correspondence Address: KLAUBER & JACKSON, 411 HACKENSACK AVENUE, HACKENSACK, NJ, 07601

(21) Appl. No.: 09/861,193

(22) Filed: May 18, 2001

Related U.S. Application Data
(63) Continuation-in-part of application No. 09/732,994, filed on Dec. 8, 2000.
Application No. 09/732,994 is a continuation-in-part of application No. 09/272,445, filed on Mar. 19, 1999, now Pat. No. 6,180,010.
(60) Provisional application No. 60/205,753, filed on May 19, 2000.

(51) Int. Cl. C02F 1/42

(52) U.S. Cl. 210/688

(57) ABSTRACT

Filtration media for removing organic contaminants from aqueous systems contacted therewith. The media comprises granulated activated carbon which has been infused with an absorption composition which is a homogenous thermal reaction product of an oil component selected from the group consisting of glycerides, fatty acids, alkenes, and alkynes, and a methacrylate or acrylate polymer component.

### RELATED APPLICATIONS

This application is a continuation-in-part of Ser. Nos. 09/732,994 filed Dec. 8, 2000; and 09/272,445, filed Mar. 19, 1999. This application also claims priority from provisional patent application Serial No. 60/205,753 filed May 19, 2000.

### FIELD OF INVENTION

This invention relates generally to methods and apparatus for removing contaminants from aqueous systems, and more specifically relates to methods and filtration devices for removing undesired contaminants such as t-butyl methyl ether (“MTBE”) from such wastestreams.

### BACKGROUND OF INVENTION

The effectiveness of GAC (granulated activated carbon) in removal of organic compounds from aqueous wastestreams is dependant upon the degree and extent of van der Waals bonding between the GAC surface and the organic pollutant. In the case of relatively water soluble, polar compounds of low molecular weight such as MTBE, hydrogen bonding creates a strong mediating influence upon the retention rate of MTBE. The result is that dwell time dependency is increased and total sorption capacity is decreased necessitating the use of large quantities of GAC to remove relatively small amounts of MTBE.

Data from various sources including GAC vendors, field trials, and laboratory tests show that the sorption capacity of GAC is in the range of 0.3 mg to 0.09 mg MTBE/gGAC or approximately 5.3 g/ft³ to 17 g/ft³.

### SUMMARY OF INVENTION

In the present invention the performance of GAC has been improved by infusing a permanent surface energy modifying agent (MYCELX™) to increase total capacity and decrease dwell time dependency. This energy modifying agent is an absorption composition comprising a homogenous thermal reaction product of an oil component selected from the group consisting of glycerides, fatty acids, alkenes, and alkynes, and a methacrylate or acrylate polymer component. In a set of tests the modified GAC was compared to standard GAC (both Bitumen grade). Dwell time was kept constant at 8 minutes (this is a fairly typical field number), and total relative MTBE capacity was determined. Total absolute capacity is dependant upon T° F., dwell time, and other factors which were kept constant. The relative capacities were of primary interest as they are an accurate reflection of relative absolute total capacity under field conditions. Individual total absolute capacity will vary based upon dwell time. T° F., other organics present and other factors. Previous laboratory and field work has demonstrated that absolute capacity in the field mirror experimentally determined relative capacities. The testing reported herein shows that the MYCELX™ modified Bitumen grade GAC has ten to fifteen times MTBE binding capacity as unmodified GAC.

The referenced MYCELX™ compositions are disclosed in the present inventor's U.S. Pat. Nos. 5,437,793; 5,698,139; 5,837,146; 5,961,823, and in 6,180,010 (all of which disclosures are hereby incorporated by reference). Although the invention is particularly useful in removing the aforementioned MTBE, other pernicious slightly soluble organic compounds can be similarly removed from aqueous systems, such as benzene, toluene, xylene, halogenated hydrocarbons, ethoxylated glycols, etc.

### BRIEF DESCRIPTION OF DRAWING

In the drawings:

The FIGURE is a schematic diagram of a laboratory system used to demonstrate the efficiency of the present invention.

### DESCRIPTION OF PREFERRED EMBODIMENTS

It should be appreciated that the use herein of the term “absorbent composition” (i.e., the MYCELX™) is one of convenience for identifying the compositions of my aforementioned patents and patent applications. The specific mechanism by which the noxious contaminants are removed from the aqueous systems by conjunctive use of the “absorbent compositions” is not completely understood, and could include attachment and/or fixation of such contaminants by mechanisms which technically involve various physical and/or chemical interactions. The term “absorbent” as used herein is intended to encompass all of these possible mechanisms.

The absorbent composition disclosed in the first of my aforementioned patents, i.e. U.S. Pat. No. 5,437,793, is characterized therein as a coagulant product which comprises a glyceride such as linseed oil reacted with a polymer such as poly (isobutyl methacrylate) which is then diluted with a solvent, such as 2,2,4-trimethyl-1,3-pentanediol monoisobutyrate. The composition formed by the thermal reaction of the linseed oil with the isobutyl methacrylate polymer is a soft resinous product which, when diluted with a solvent, results in a mixture that in the teaching of the said patent can be sprayed onto an oil spill or otherwise introduced to the oil spill to coagulate the oil. Additionally, however, and as disclosed in my further U.S. Pat. No. 5,698,139 and additional patents above cited, further experimentation has led to the discovery of additional absorbent compositions produced from polymers and a variety of natural animal and vegetable oils, fatty acids, alkenes and alkynes, which absorbent compositions are all utilizable in the filters and filtration processes of the present invention. More generally these latter compositions are the thermal reaction product of a polymer component with an oil component selected from the group consisting of glycerides, fatty acids, alkenes and alkynes. The reaction conditions can be adjusted to provide a “first endpoint” product or a “second endpoint” product. Preferred compositions are disclosed which comprise the thermal reaction products of methacrylate polymers with a glyceride derived from a variety of natural animal and vegetable oils, or the thermal reaction products of methacrylate polymers with a fatty acid or alkene or alkyne containing from about 8-24 carbon atoms. The combination of a methacrylate polymer component with any of these oil components can provide either a first or second endpoint product, depending upon the reaction conditions. The term “first endpoint product” is used to describe the solubility product of the reaction which is a cooperative structure held together by many reinforcing, noncovalent interactions, including Van der Waals attractive forces. The term “second endpoint product” is used to describe the product of the reaction which is the result of covalent bond formation between the polymer component and the oil component, as indicated by the change in molecular weight.

The absorbent composition is readily synthesized from a polymer component and an oil component selected from the group consisting of glycerides, fatty acids, alkenes and alkynes. In a preferred embodiment, the product is synthesized from an isobutyl methacrylate polymer, and the oil component is one derived from a natural oil, such as linseed oil or sunflower oil. Optionally, the composition is then diluted with a solvent, such as 2,2,4-trimethyl-1,3-pentanediol monoisobutyrate or acetone. The diluted composition can then be applied to a desired substrate for use as a filtration media pursuant to the present invention.

The polymer component of the absorbent composition is a synthetic polymer such as polymers derived from methacrylates. Preferably, the polymer is derived from methyl methacrylate, ethyl methacrylate, isobutyl methacrylate, or n-butyl methacrylate, or may be a copolymer containing a methacrylate polymer. Most preferably, the polymer is a poly(isobutyl methacrylate) polymer such as that obtainable from ICI Acrylics as ELVACITE® 2045, or a methacrylate/methacrylic acid copolymer such as ELVACITE® 2008 or 2043. However, it is anticipated that other equivalent polymers can be used to prepare equivalent compositions of the invention. Combinations of polymers can be used to advantage in the preparation of the absorbent compositions.

The test used to determine whether or not a polymer can be used in preparing the absorbent compositions of the present invention is to combine the polymer component in question with the oil component, as set forth herein, to see if the resultant combination forms a homogenous product after heating. Ideally, the polymer component percentage of the composition should range from about 15-75%, preferably 20-40%, or more preferably from about 25-35%, by weight.

In one embodiment of the absorbent composition, the oil component of the composition is a glyceride derived from oils of vegetable or animal origin. Vegetable oils are obtained by cold pressing the seeds of a plant to obtain the oil contained therein. Of the vegetable oils, drying oils such as sunflower, tung, linseed, and the like; and semi-drying oils, such as soybean and cottonseed oil, have been shown to be useful as the glyceride component of the invention. Animal oils, such as, for example, fish oil, tallow and lard can also be used as a glyceride component of the composition. It is anticipated that any drying oil or semi-drying oil will work in the composition. Generally, a drying oil is defined as a spreadable liquid that will react with oxygen to form a comparatively dry film. Optionally, combinations of two or more glycerides can be used as reactants with the polymer to provide absorbent compositions useful in the present invention.

In a preferred embodiment, the oil component of the absorbent composition is a glyceride derived from a drying oil, such as linseed oil, that can be obtained from Cargill, Inc. as Supreme Linseed Oil, or sunflower oil. The glyceride should comprise from about 25-85%, preferably about 60-80%, and most preferably, from about 65-75% of the coagulant composition. All percentages in this disclosure are by weight, unless otherwise stated.

Where the oil component of the composition is a fatty acid or alkene or alkyne utilized as the reactant with the polymer, it contains from about 8 to 24 carbon atoms, and preferably from about 10 to 22 carbon atoms. Such fatty acids, alkenes and alkynes are commercially available from many suppliers. Typical fatty acids include both saturated and unsaturated fatty acids, such as lauric acid [dodecanoic acid], linolenic acid, cis-5-dodecanoic acid, oleic acid, erucic acid [cis-docosanoic acid], 10-undecynoic acid, stearic acid, caprylic acid, caproic acid, capric acid [decanoic acid], palmitic acid, docosanoic acid, myristoleic acid [cis-9-tetradecenoic acid], and linoleic acid. Typical alkenes and alkynes contain at least one and preferably one or two degrees of unsaturation, and from about 8 to 24 carbon atoms, with 10-20 carbon atoms being preferred. Preferred alkenes and alkynes are those such as 1-decene, trans-5-decene, trans-7-tetradecene, 1,13-tetradecadiene, 1-tetradecene, 1-decyne, and 5,7-dodecadiyne.

The absorbent composition is a product with characteristics different from either of the starting materials or a simple mixture of the two starting materials, thus showing that a new composition is produced by the thermal reaction. Specifically, the oil/polymer absorbent compositions pass a clear pill test after being heated at the elevated temperatures and do not separate into two parts upon being cooled but, rather form a homogenous, uniphase compound.

More specifically, the solvent can be selected from aliphatic hydrocarbons, aromatic hydrocarbons, alcohols, ketones, ethers, aldehydes, phenols, carboxylic acids, synthetic chemicals and naturally occurring substances.

The absorbent composition used in the present invention may be prepared by a thermal reaction process. The first step of the process involves heating the oil component (glyceride or fatty acid or alkene or alkyne) to approximately 235-350° F. at a rate of about 5° F. per minute with continuous stirring. Then, the polymer component, usually in powdered form, is slowly stirred into the heated oil component. Depending upon the particular reactants used, the oil component should range from about 25-85%, preferably about 65-80%, more preferably about 72-77%, and the polymer should range from about 1-50%, preferably about 20-40%, more preferably about 23-28%, of the coagulant composition. After this mixture has been mixed properly, the mixture should be heated to approximately 400-700° F., depending on the particular components utilized for the reaction, and the desired endpoint of the reaction.

Typically, reaction temperatures below about 500° F. produce “first endpoint products” while temperatures above about 500° F. produce “second endpoint products” The mixture should be heated at that temperature until a clear pill test indicates that the reaction has reached its first end point, i.e., a drop of the reaction mixture when placed on a clear glass plate is clear. When a clear pill test indicates that the reaction has reached its first end-point, the mixture should be cooled to a temperature below 200° F., generally about 180° F. After cooling, the coagulant product can be diluted with a suitable solvent to form a more liquid product that is easier to handle and use. The temperature at which the solvent is added is not critical, but the solvent should be added at a temperature where the coagulant composition is still pliable and the solvent will not rapidly evaporate.

Two reactions appear to occur between the oil component and the polymer component based upon the temperature and time. The first endpoint of the reaction results in a rubbery viscoelastic, relatively soft product with a melting point in the range of 100° F. to 250° F. This first endpoint product is homogeneous and does not separate upon melting or dissolution. This reaction occurs at 350° F.-500° F. This is designated the “first endpoint product” (solubility product).

In the second reaction, the polymer undergoes complete or partial chain fission into discrete polymer free radicals at a temperature above about 500° F. At between 350° F. to 500° F., it is believed that partial chain fission of the polymer component (isobutylmethacrylate polymer has a m.w.=300,000 Daltons) occurs at the end of the chain or in the middle. This results in a lower molecular weight product. It is believed that there may also be a solubility reaction occurring (similar to Sn and Pb forming solder) within the ternary composition. The occurrence of a chemical reaction is confirmed, however, due to the change of molecular weight.

Reactions at above 500° F. and up to 900° F. maintained at temperature from 5 minutes to 20 hours, depending on activation energy of compositions, result in the second endpoint product. This reaction is visually observable by color, rheology, and specific heat change in the product [Note: For the first endpoint product the end of the reaction is observed by change in color and a rheology change and the cessation of solution outgassing. There is also a change in specific heat as measured by Differential Scanning Calorimetry]. The second endpoint product has a weight average molecular weight in the range of about 62,000 Daltons which is consistent with complete chain fission of the polymer, resulting in smaller free radicals which results in a lower molecular weight compound. The melting point of these products is usually above 300° F. if the oil component is highly unsaturated, which results in a solid product due to the formation of highly bonded three dimensional densely packed molecular matrix. If the oil component has a low degree of unsaturation, the resultant product is usually liquid, which is consistent with this type of reaction.

The oily component and the polymer component are reacted in a thermal reaction that does not appear to be sensitive to the atmosphere under which the reaction is carried out, i.e., whether it is an inert, oxidizing or reducing atmosphere. Absorbent compositions have been prepared by this reaction which range from soft to hard, and elastomeric to brittle in nature depending upon the ratio of the oil component to the polymer component and the choice of the polymer component and/or the oil component used. If the reaction mixture separates into two phases upon cooling it is not useful for the invention. In this manner, any polymer can be identified for use in the invention.

The mechanism of the thermal reaction remains to be elucidated. While not wishing to be bound by any theory in this regard the reaction appears to be a polymerization or phase transition reaction brought about by heat and which is stable at lower temperatures. It is hypothesized that the elevated temperatures create monomer free radicals of the polymers and copolymers which then crosslink with the unsaturated glyceride molecules. It is also hypothesized that perhaps a phase transition is occurring between the oil component and the polymer component. In an effort to determine what type of interaction or reaction is occurring between the oil component and the polymer component, thermal analysis of several of the absorbent compositions was conducted. The results indicate that a reaction is occurring between the oil component and the polymer.

Differential scanning calorimetry (DSC) was thus performed on several such compositions. DSC is a thermal analysis technique that measure the quantity of energy absorbed or evolved by a sample in calories as its temperature is changed. The sample and a reference material are heated at a programmed rate. At a transition point in the sample's heating, such as when it reaches a melting point, the sample requires more or less energy than the reference to heat. These points are indicated the typical DSC readout.

Samples were taken at the beginning of the reaction procedure described earlier and at the end of the reaction. The DSC profile for the initial starting materials is dramatically different from the profile of the product. The initial profile showed two exothermic events when the DSC analysis is carried out from 40-280° C., one event occurring at about 100° C. and the other at about 217° C. In the DSC profile of the reaction product, however, there was only one exothermic event, occurring at about 261° C. The samples were taken at initial and final points during the reaction and allowed to cool to room temperature before being subjected to the DSC.

In the instance of a further reaction, DSC's of the starting materials and final product were obtained. Again, the DSC curves generated show that two thermal events occurred for the “just mixed” reactants while only one thermal event occurred for the final product. Thus, the DSCs indicated that the occurrence of a reaction or phase transformation. Similar evidence obtained from IR spectra analysis also confirms that the absorbent compositions used in the invention are distinct products from the reactants used to prepare the absorbent compositions.

In a typical procedure the GAC is infused with 8-15% of the absorbent composition. This can e.g., be accomplished by covering the GAC with a 10% solution of the absorbent, allowing the mix to stand for 24 hours, then draining and drying the GAC and curing the treated GAC for 7-10 days.

### EXAMPLE 1

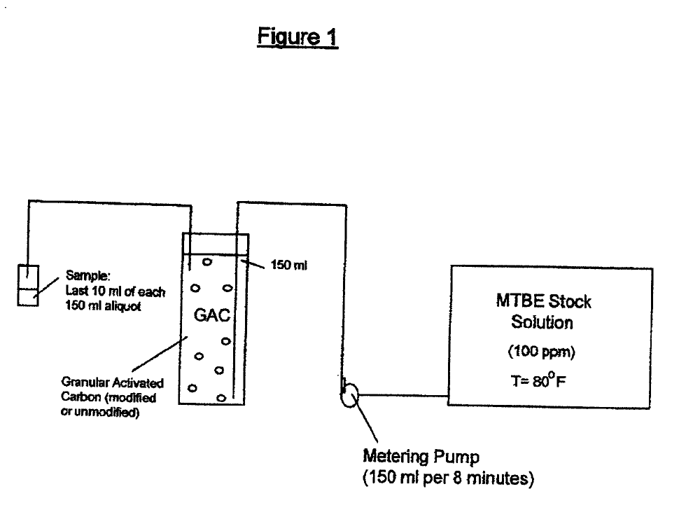

A fluidized bed GAC system was constructed using lab apparatus. (see FIG. 1). Glass was used wherever possible to minimize MTBE sorption by polymeric materials such as neoprene gaskets, etc. The entire apparatus was preconditioned using a standard MTBE solution so that any sorption and dissolution taking place would be at equilibrium. A 150 m. glass column was filled with a pre-weighed amount of the material to be tested. The unit was primed with 200 ml of de-ionized water. 50 ml samples of 100 ppm MTBE solution were process through the unit and the last 10 ml was collected and analyzed using a gas chromatograph. The process was repeated until MTBE break-through was detected. Flow rate was 150 ml/8 minutes. The results are set forth in Table I below:

TABLE I

| | | | |
|---|---|---|---|
| Flow Rate | = | 150 | ml/8 min |
| Wt GAC | = | 70 | gm |
| T° F. | = | | Ambient |
| Dwell Time | = | 8 | minutes |
| Influent | = | 100 | ppm MTBE in distilled water concentration |
| Detection Limit | = | 1 | ppm |
| Sample Size | = | 50 | ml |
| BDL | = | | Below Detectable Limits |

| | | | Unmodified | |
|---|---|---|---|---|
| | | mg MTBE | GAC Effluent | Modified GAC |
| Sample # | ml | Removed | Concentration | Effluent Concentration |
| Control | | | 100 ppm | 100 ppm |
| Blank | | | BDL | BDL |
| #1 | 50 | 5 | BDL | BDL |
| #2 | 100 | 10 | BDL | BDL |
| #3 | 150 | 15 | 90 ppm | BDL |
| #4 | 200 | 20 | | BDL |
| #5 | 250 | 25 | | BDL |
| #6 | 300 | 30 | | BDL |
| #7 | 350 | 35 | | BDL |
| #8 | 400 | 40 | | BLD |
| #9 | 450 | 45 | | BDL |
| #10 | 500 | 50 | | BDL |
| #11 | 550 | 55 | | BDL |
| #12 | 600 | 60 | | BDL |
| #13 | 650 | 65 | | 10 ppm |
| #14 | 700 | 70 | | 36 ppm |
| #15 | 750 | 75 | | 39 ppm |

### EXAMPLE 2

The procedure of Example 1 was repeated to enable a comparison between absorption by unmodified and modified GAC. The results are seen in Table II.

TABLE II

| | | | | gm MTBE | gm MTBE | |
|---|---|---|---|---|---|---|
| | ml Water | wt MTBE | | Removed | Removed | |
| | Processed | Removed (mg) | | gm GAC | ft³ GAC | |
| Unmodified | 150 | 11 | mg | 0.13 | 2.4 | gm/ft³ |
| GAC | | | | | | |
| Modified | 750 | 82 | mg | 1.1 | 20.2 | gm/ft³ |
| GAC | | | | | | |

Discussion:
Unmodified GAG removes about .13 mg MTBE/gm GAG and was able to treat between 100 to 150 ml 100 ppm MTBE solution before breakthrough. As predicted by generally accepted models for the mechanism and mode of GAC adsorption, once saturation was reached almost total breakthrough occurred.
In contrast the modified GAC of the invention adsorbed 1.1 mg MTBE/g unmodified GAG and was able to treat about 750 ml of 100 ppm MTBE solution. Additionally breakthrough occurs gradually with only about 30 ppm breaking throughafter 15^{th} sample. It may be economically desirable for GAC filters in series to practice counter-current replacement of the filters to prolong effective life even further.
Conclusion:
Modified GAC is seen to have approximately 10 times the capacity of unmodified GAC. Additionally, gradual breakthrough may make it possible to extend the life of the GAC another 50% or approximately to 1.7 mg MTBE adsorbed/g modified GAC (˜30 gm/ft³) by using countercurrent techniques. In principle the cost of MTBE treatment can thereby be reduced by 50% to 90%.

While the present invention has been set forth in terms of specific embodiments thereof, the instant disclosure is such that numerous variations upon the invention are now enabled to those skilled in the art, which variations yet reside within the scope of the present teaching. Accordingly, the invention is to be broadly construed and limited only by the scope and spirit of the claims appended hereto.

What is claimed is:

1. Filtration media for removing organic contaminants from aqueous systems contacted therewith, comprising granulated activated carbon which has been infused with an absorption composition comprising a homogenous thermal reaction product of an oil component selected from the group consisting of glycerides, fatty acids, alkenes, and alkynes, and a methacrylate or acrylate polymer component.

2. Filtration media in accordance with claim 1, wherein said absorption composition has been cured in situ at said media.

3. Filtration media in accordance with claim 1, wherein said granulated activated carbon is in the form of a bed.

4. A method for removing organic contaminants from an aqueous phase in which the contaminant is contained, comprising:
passing said aqueous phase through a filtration bed comprising granular activated carbon which has been infused with an absorption composition comprising a homogenous thermal reaction product of an oil component selected from the group consisting of glycerides, fatty acids, alkenes, and alkynes, and a methacrylate or acrylate polymer component; said contaminant being thereby immobilized at said infused activated carbon; and
collecting the purified filtrate having passed through said filtration bed.

5. A method in accordance with claim 4, wherein the said contaminant is MTBE.

6. A method in accordance with claim 4, wherein the said contaminant is benzene.

7. A method in accordance with claim 4, wherein the said contaminant is toluene.

8. A method in accordance with claim 4, wherein the said contaminant is xylene.

9. A method in accordance with claim 4, wherein the said contaminant is a halogenated hydrocarbon.

10. A method in accordance with claim 4, wherein the said contaminant is an ethoxylated glycol.
